(19) United States
(12) Patent Application Publication
(10) Pub. No.: US 2026/0288689 A1
(43) Pub. Date: Sep. 24, 2026

(54) SYSTEM AND METHOD FOR DYNAMIC, CONTEXT-AWARE USER INTERFACE GENERATION USING ARTIFICIAL INTELLIGENCE MODELS

(71) Applicant: Vaadin Ltd., Turku (FI)

(72) Inventors: Joonas Juhani LEHTINEN, San Jose, CA (US); Marcus HELLBERG, Espoo (FI); Tomi VIRKKI, Turku (FI)

(21) Appl. No.: 19/394,848

(22) Filed: Nov. 19, 2025

Related U.S. Application Data
(60) Provisional application No. 63/775,251, filed on Mar. 20, 2025.

(51) Int. Cl. G06F 16/22; G06F 16/23; G06F 16/28

(52) U.S. Cl. CPC G06F 16/2246; G06F 16/235; G06F 16/282

(57) ABSTRACT

Methods and systems are disclosed for dynamic and real-time user interface (UI) generation by generating an initial UI based on a structured dataset representing the UI, wherein the structured dataset is determined using an artificial intelligence (AI) model characterized by datasets based on other computer UIs; receiving first information representing an interaction event for the initial UI; updating the structured dataset in response to the first information, wherein the updated structured dataset represents an updated UI; and generating an updated UI based on the updated structured dataset. The AI model can be a Large Language Model (LLM). The AI model can be fine-tuned and/or prompted based on input data associated with the other computer UIs. The operations for dynamic and real-time UI generation can repeat in multiple cycles. The initial UI can be cached for ongoing cycles of UI generation.

### RELATED APPLICATION

This application claims priority to U.S. Provisional Application No. 63/775,251, which was filed on Mar. 20, 2025. The provisional application is incorporated herein by reference for all purposes.

### TECHNICAL FIELD

The present disclosure relates generally to improving computer user interfaces (UI) and more specifically to real-time and dynamic generation of UIs driven by artificial intelligence (AI).

### BACKGROUND

The Human-Computer Interface (HCI) paradigm has traditionally focused on enabling humans to interact with computers through well-defined user interfaces (UIs). With the rise of artificial intelligence (AI) agents, these traditional roles may be reversed such that computers initiate interactions with users in a “Computer-Human Interface (CHI)” paradigm.

Per the CHI paradigm, in which a computer initiates communications with human users, Al agents may seek approval or authorization from humans before executing certain actions and/or may seek guidance from users when attempting to solve complex problems. Moreover, AI agents may seek guidance from users on how to provide information or insights effectively beyond user interfaces (UIs) that generate simple textual and/or audible voice-generated responses.

Besides UIs that generate textual and voice-generated responses, graphical user interfaces (GUI) have been developed in which a computer can convey information to users via graphical images, symbols, pictures, etc. However, traditional GUIs require predefined UI elements and substantial programming and design prior to interacting with users. As such, traditional GUIs lack flexibility and are unable to adapt to the specific environments, contexts, and interactions that users may require based on the wide variety of information that the users are seeking and the different business, personal, and other types of AI applications and platforms used in the computer systems'interactions with users.

### SUMMARY

The present disclosure describes systems and computer-implemented methods to improve applications where AI agents dynamically generate UI elements on demand, based on the specific context and purpose of interactions with users. This eliminates the need for pre-programmed UI definitions and elements and allows the GUIs and underlying AI to adapt and evolve in real-time based on the interaction with users and their needs.

In one embodiment, the disclosed systems and computer-implemented methods include a high-level User Interface Definition Language (UIDL) and a runtime system that generates GUIs dynamically based on the context and/or application of user interactions. In some examples, the UIDL system provides a structured syntax for dynamically defining UI formats and elements, abstracted from specific application logic.

In another embodiment, an AI model, such as a Large Language Model (LLM), is trained and/or fine-tuned to: (1) generate contents of the UIDL data in response to user interactions, the state of the computer system, and/or the history user interactions; (2) process and adapt UI components in real-time based on user inputs, including text, voice, and/or event-driven interactions; and (3) interpret and modify GUI layouts dynamically, ensuring seamless interaction without predefined templates or manually-developed templates.

In yet a further embodiment, the runtime system captures and processes user-generated events (clicks, selections, input fields) and feeds them back into the LLM, enabling a continuous feedback loop for UI adaptation. In some examples, the runtime system interacts with external systems through function calls to request more information as needed for the user interaction or to store data or requests as an output from the interaction. By decoupling UI creation from business and/or application logic, the disclosed systems and computer-implemented methods allow AI agents to autonomously construct, modify, and refine UIs in real-time, providing a flexible, non-linear, and fully adaptive user experience.

In a further embodiment, systems and methods for dynamically generating graphical user interfaces (GUIs) use Large Language Models (LLMs) and eliminate the need for predefined business and/or application logic or manual UI development. A User Interface Definition Language (UIDL) serves as an intermediate representation for describing UI elements, layouts, and interactions. An LLM-based UI generation engine interprets user inputs (such as text commands, voice commands, mouse inputs, etc.) and/or contextual data to produce real-time and adaptive UI definitions for UI elements. In this regard, a runtime UI rendering engine processes the UIDL to generate the corresponding GUI dynamically. Further, an “event feedback” mechanism captures user interactions (e.g., clicks, selections, text input, etc.) and supplies them back to the LLM, which in turn, generates new UI elements that are tailored to the current and evolving interactions with users. By implementing such a technique, the systems and methods enable continuous UI refinement and real-time adaptation to the user interactions. This, in turn, enables the systems and methods to appear more “humanlike” to users, provides a more relevant and intuitive interface for users to obtain the information they need, and seamlessly adapts to the applications for which users are accessing (or benefitting from) the underlying AI. By decoupling UI generation from pre-defined UI elements/design and application logic, the disclosed systems and methods enable AI-driven, context-aware user interfaces that can be dynamically created, modified, and optimized based on real-time interactions with user.

### BRIEF DESCRIPTION OF THE DRAWINGS

FIG. 1. is a simplified diagram illustrating an exemplary user interface (UI) generation system using AI, in accordance with some embodiments.

FIG. 2 is a simplified diagram illustrating the operation of a system for generating user interfaces (UIs) using AI, in accordance with some embodiments.

FIG. 3 is a diagram illustrating an example of a user interface (UI) generated using AI, in accordance with some embodiments.

FIG. 4 is a simplified diagram illustrating the operation of a system for generating user interfaces (UIs) using AI, in accordance with some embodiments.

FIG. 5 is a simplified diagram illustrating the operation of a system for generating user interfaces (UIs) using AI, in accordance with some embodiments.

FIG. 6 is a flow chart illustrating an exemplary method for generating user interfaces (UIs) using AI, in accordance with some embodiments.

Various objectives, features, and advantages of the disclosed subject matter can be more fully appreciated with reference to the following detailed description of the disclosed subject matter when considered in connection with the drawings, in which like reference numerals identify like elements.

### DETAILED DESCRIPTION

In accordance with some embodiments, the disclosed systems and computer-implemented methods include a system for dynamic, context-aware user interface (UI) generation using artificial intelligence (AI) models, such as large language models (LLMs). The system operates on a computer processor, which continuously and/or iteratively generates, renders, and adapts graphical user interfaces (GUIs) in real-time, based on evolving user interactions, context, and task-specific goals. In some examples, to facilitate interactions with a human user, the system is initiated with specific inputs. The “entity” that initiates the system with specific inputs may include an AI agent, a conventional software application, such as business process management system, or a human that provides a task for the system to handle or resolve.

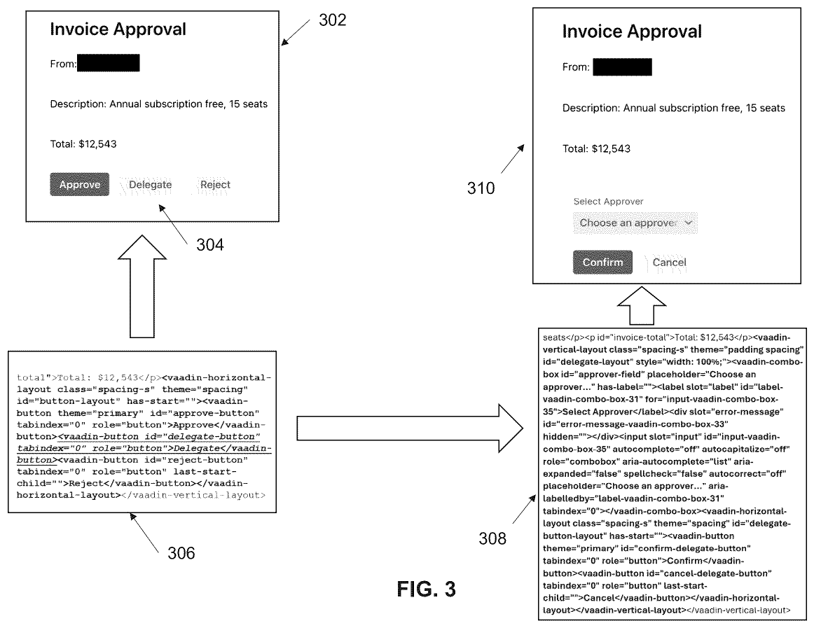

Examples of the specific inputs that may be used to initiate the system include user-defined task descriptions, result formats, budget of system operations, and/or background data. For instance, user-defined task descriptions may provide the AI agent with a goal of a current operation, such as “find a suitable non-stop flight from San Francisco (SFO) airport to Narita (NRT) airport based on the user's preference for departure/return dates.” Result formats constrain the LLM's output such that the AI agent can properly operate upon various data, such as the booked flight numbers and departure/return dates stored in JavaScript Object Notation (JSON) format. JSON is a lightweight, text-based data interchange format that represents structured data with key-value pairs and arrays. Budget of system operations may bound the cost of computing resources, such as token spending, model tier, and cost associated with function calls. Examples of background data include user preferences (such as preferred airlines), device capabilities (such as whether a device's microphone is available, the resolution of the device's display screen, etc.). Inputs to the disclosed system can also include UIDL definitions contained in User Interface Definition Language (UIDL) data representing an initial UI state, data representing UI best practices, and algorithms representing rule-based operations for the generation of UIs. The inputs to the disclosed system may prompt and/or fine-tune an LLM for generating UIs without requiring predefined business logic, static UI components, or manual application development. In an example, UIDL data representing an initial UI state is a self-contained declarative JSON specification that the system rendering a UI uses to build an initial live form UI. Further, the description of FIG. 3 below provides some examples of the UIDL data. Also, by using definitions of the UIDL, UIs can be generated and updated dynamically at runtime of the computing system. Any manual application development, such as hand-coding UI pages, writing computer language scripts, or redeploying applications whenever a UI form is changed is not required.

For the operation of the disclosed system, a textual description of the task or outcome that the AI agent aims to achieve through user interaction can be provided. For example, the task or outcome may include obtaining approval (such as authorization for critical actions), gathering user-provided guidance, teaching a user ideas or information, or showing user background data. For instance, the textual description of the task or outcome passed to the LLM may be “before permanently deleting any file that has been tagged as sensitive, the UI should (1) present the user a table of candidate files for deletion with file sizes and last-access metadata, (2) obtain from the user guidance about what files should be deleted and when, (3) teach the user about the computer document retention policy in effect, and (4) require explicit approval from the user to delete a file by capturing a user-typed phrase ‘DELETE’ associated with a mandatory input filed for reason.”

Examples of the background data include contextual data, such as free-form text, structured data, multimedia content (e.g., voice inputs), and other contextual information relevant to the interaction. The disclosed system is designed to accept various data formats, including text descriptions, JSON data structures, images, audio transcripts, etc. For instance, the background contextual data about user preferences, which is described above is in the example for booking an airline flight, can be a text input, such as “the user prefers flights operated by Japanese airlines,” or a voice input from the user stating that “I prefer flights that depart at night time.”

In accordance with some embodiments, the disclosed systems and computer-implemented methods include functions for external interaction. When these functions are executed via a processor, they act as connectors or interfaces for retrieving additional data (such as permissions and roles of certain users, pricing and quotas of certain goods and/or services, inventory and service availability, calendar of events, etc.) from external systems such as databases, Application Programming Interfaces (APIs), calendars, Internet of Things (IoT) sensors, and other sources of data. They also enable actions, such as creating calendar entries, initiating transactions, or updating records in external databases. Each function may be documented with clearly defined input and output structures that the LLM can dynamically invoke as necessary during interactions with the sources of data, human users, other applications, and/or other systems.

In accordance with some embodiments, the disclosed system calls external functions to request additional information and/or to invoke operations on external systems (for instance, using Model Context Protocol (MCP)). In some examples, when certain external functions have associated monetary or computational costs, the disclosed system may be provided with a defined budget to limit expenditures. The LLM can be utilized to manage and track the usage of these external interactions to ensure that the applications remain cost-effective. For instance, a session budget and a per-call maximum cost can be passed to the LLM such that the LLM maintains a cost meter. The cost meter may keep track of estimated costs of each function call and binds each user action to a tool contract so the user can refrain from inputting another command (e.g., a mouse click) if the command would exceed the session budget or the per-call maximum cost.

In some embodiments, the system and method output a structured definition of what information or final state the system returns upon completion, enabling clarity and precision when concluding interactions. The disclosed system can save results in a structured output format (e.g., JSON) that is consistent with pre-defined result format. For instance, a pre-defined result format (or data schema) that requires specific JSON fields (such as “ui_schema_id” and a “components[] array” of fields like “id”, “label”) may be passed to the LLM. Given this schema, the LLM returns a structured JSON object that conforms to these fields after completion of its session.

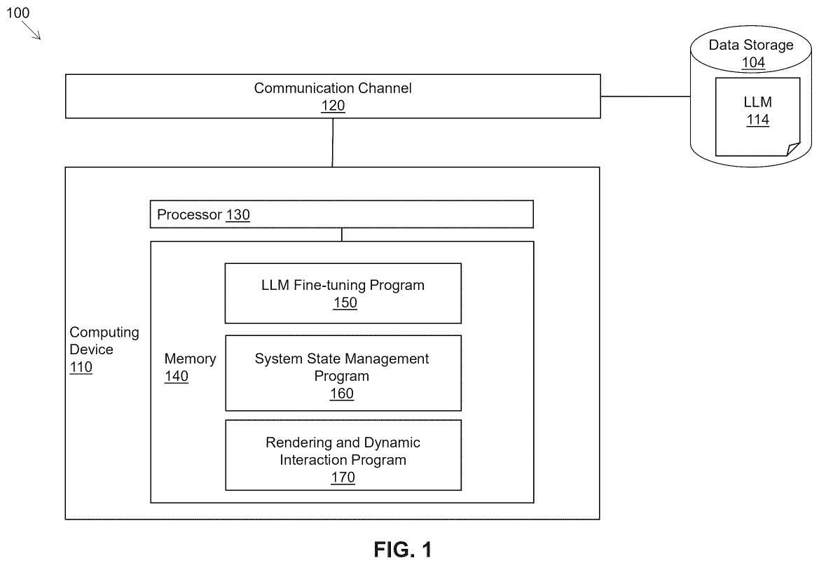

FIG. 1 illustrates an exemplary system 100 for real-time and dynamic generation of UIs, in accordance with some embodiments. In the illustrated example, the system 100 includes data storage 104 and a computing device 110. The data storage 104 is communicatively coupled to the computing device 110 via a communication channel 120. Examples of the computing device 110 generally include a computing device or system, such as personal computer, an on-premises server, a cloud-based server, or the like. Examples of the communication channel 120 generally include wired and/or wireless links, and/or a network including one or more local area networks (LANs), wide area networks (WANs), wired networks, wireless networks, the Internet, or data/control signal links within the same computing system. In other embodiments, the data storage 104 is directly connected to and/or integrated within the computing device 110.

In accordance with some embodiments, the data storage 104 is configured to store, register, and/or maintain an AI model such as a Large Language Model (LLM) 114. For instance, the LLM 114 may include a collection of data comprising core weights, tokenizer assets, and metadata for configuration purposes. Core weights are numerical parameters for the LLM 114 that have been obtained through training the model. Core weights dictate the model's knowledge and behavior so that certain behavioral aspects are favored more than others. Tokenizer assets map raw text to tokens, which are basic units of text an LLM reads and writes. Tokenizer assets ensure textual input is divided into tokens in the same way that tokens were input to the LLM while it was trained so that the LLM's outputs can be converted back into text correctly. Configuration metadata generally comprises non-trained settings such as an architecture shape of the model. In some examples, optional adapter packages (for instance, prefix data, fine-tuning data, and/or prompt tuning vectors) can also be stored and maintained as a separate data collection linked to the base data collection of the LLM. This enables selective composition of the model, and thus the model's behavior, at runtime without having to alter the base weights of the base model. For instance, prefix data may be appended to text input to the LLM so that the LLM's behavior is specially adapted to perform certain tasks or operate in specific domains during an inference stage of the model. Fine-tuning data are parameter updates, which are trained on task and/or domain specialized data, for the base model weights. At an inference stage, a runtime system uses the fine-tuning data on top of base model weights to form the effective model with “revised” weights.”. Prompt-tuning vectors are learned embedding vectors that act as extra tokens prepended to the text input to the LLM. They condition the model toward desired outputs based on task and/or domain specialization.

The LLM 114 can be invoked by the computing device 110 when other computer functions (for instance, an AI agent, prompt orchestration program, a software tool bridge, or input from a user) call the LLM 114 via a software invocation path and the communication channel 120. For instance, the prompt orchestration program may be a process executed via the processor 130 that builds inputs for the LLM 114 and interprets its outputs. For inputs, this process may assemble instructions, context, schemas, guardrails, examples, and budgets into a structured prompt. For outputs, this process may postprocess the model's response so downstream programs can act on the response deterministically. The software tool bridge is a middle layer process executed via the processor 130 that connects the LLM 114 to external tool functions and systems. This middle layer process turns model intents into API calls while handling constraints with these API calls.

In the illustrated example, the computing device 110 includes a processor 130 (e.g., one or more hardware processors) coupled to a memory 140 (e.g., one or more non-transitory memories). The memory 140 stores instructions and/or data. When executed by the processor 330, the instructions and/or data stored in the memory 140 cause the processor 130 to perform operations associated with real-time and dynamic generation of UIs without requiring predefined business logic, static UI components, or manual application development.

For instance, in accordance with some embodiments, the memory 140 stores instructions and/or data corresponding to an LLM fine-tuning program 150, a system state management program 160, and a rendering and dynamic interaction program 170. When executed by the processor 130, the programs 150, 160, and 170, each or in any combination thereof, cause the processor 130 to leverage the LLM 114 and perform operations associated with real-time and dynamic generation of UIs without requiring predefined business logic, static UI components, or manual application development.

In an embodiment, the LLM fine-tuning program 150 causes the processor 130 to refine the LLM 114 (for instance, a foundation model such as GPT-4 or similar transformer-based architectures) for the operation of real-time and dynamic generation of UIs without requiring predefined business logic, static UI components, or manual application development. In some examples, UIDL specification training is performed by the LLM fine-tuning program 150 in order to teach the LLM 114 to generate a valid and renderable UI following the definitions within the UIDL. More specifically, the LLM 114 is fine-tuned or prompted in accordance with a specific UIDL, which is maintained in the memory 140 as a data collection. The UIDL data collection comprises a comprehensive syntax to define UI elements, interactions, component structures, and behaviors independent from underlying application logic. For instance, when the LLM 114 generates UI specifications based on the UIDL, it does not rely on hardcoding any specific backend programming code (such as JavaScript).

In another embodiment, datasets comprising interaction patterns between computers and human users are utilized by the LLM fine-tuning program 150 when executed by the processor 130. Fine-tuning operations performed by the LLM fine-tuning program 150 include training the LLM 114 on patterns of improved UI design, usability principles, and responsive interaction techniques. The training dataset encompasses recommended layouts, standard interaction flows, best practices, and typical UI metaphors (e.g., “form” and “wizard” referring to fields and multi-step navigation through multiple UI pages). The LLM fine-tuning program 150 can also utilize the generalized intelligence of the LLM 114 to dynamically generate new and contextually appropriate UI solutions.

In another embodiment, user feedback integration is performed by the LLM fine-tuning program 150 when executed by the processor 130. Throughout the operation of the system 100, human users can provide explicit feedback regarding the usability, effectiveness, and/or clarity of generated UIs. The continuous feedback process is a loop operation performed by the processor 130, which allows incremental retraining or online fine-tuning of the LLM 114. The loop operation progressively refines the UI-generation capabilities of the system 100.

In another embodiment, the LLM fine-tuning program 150 further comprises a rule-based subsystem (e.g., a rule engine that executes rules according to some algorithm). When executed by the processor 130, the LLM fine-tuning program 150 causes the system 100 to perform UI generation functions in accordance with safety and compliance rules of the rule-based subsystem. As a result, the system 100 adheres to predefined rules establishing interaction boundaries, appropriate behaviors, cultural sensitivity, tone of voice, and permissible content. Regular evaluations and iterative updates ensure that the system 100's output remains aligned with organizational, ethical, and regulatory standards. Moreover, these rules may vary, as appropriate, by continent, country, region, state, or city in which the system is used to account for different cultures, laws, and/or regulations in these areas.

In an embodiment, when executed by the processor 130, the system state management program 160 causes the processor 130 to maintain and store in the memory 140 a separate UI state outside of the LLM session. That is, the system state management program 160, which is executed by the processor 130 rather than the LLM 114, holds authoritative UI data (such as field values, validation status, component version) in data storage controlled by the program 160. The UI state may comprise two interconnected datasets. The first dataset includes a hierarchical UI component tree, which represents the UI structure through component nodes (e.g., buttons, forms, images, etc.) and interaction events (e.g., mouse click, finger swipe, drag-and-drop operation, etc.). Data corresponding to these component nodes and interaction events can be bound to external data or function calls. During operations of UI generation, based on data corresponding to these component nodes and interaction events, each node is rendered independently by the rendering and dynamic interaction program 170 which provides granular and dynamic updates of UIs. The second dataset of the UI state may be stored in the memory 140 and may include value state data, which is a structured object that captures current values and data presented in the UI. The value state data also maintains output values for the system 100.

In an embodiment, when executed by the processor 130, the rendering and dynamic interaction program 170 causes the processor 130 to execute a continuous rendering and interaction loop for real-time and dynamic generation of UIs without requiring predefined business logic, static UI components, or manual application development. At the beginning of the continuous rendering and interaction loop, initial UI generation is performed by the rendering and dynamic interaction program 170. The program 170 interacts with the LLM 114 to generate the initial UIDL representation dataset based on the provided goal, initial context, and state. The UIDL representation dataset can be parsed and rendered into a fully interactive GUI on target platforms and/or devices (for instance, web browser, mobile device, desktop computer, or AR/VR environments and devices).

In accordance with some embodiments, the initial UIDL representation dataset may be cached and stored in a dedicated database in the memory 140 and/or in a data storage of the computing device 110. During the current continuous rendering and interaction loop for real-time and dynamic generation of UIs, or any of future continuous rendering and interaction loops, when a new UI request or prompt for generating a UI is received and is comparable to the request or prompt represented by the cached initial UIDL dataset, the rendering and dynamic interaction program 170 can fetch this initial UIDL dataset. Based on this pre-stored initial UIDL dataset, the program 170 may operate with the LLM 114 based on the pre-stored initial UIDL dataset to produce the initial UI state. When initializing a continuous rendering and interaction loop with the pre-stored initial UIDL dataset representing an initial UI state, the system 100 saves processing time, including that of the processor 130, and thus reduces the latency of the UI generation. The system 100 can also guarantee that the initial UI state is identical or similar to what has been used previously by a human user, improving consistency of the performance of the system 100 and allowing the human user to review the quality of and approve of the generated UI before the UI is sent to any other entity, such as another human user, another computer entity, or application. In some examples, based on inputs from the user of the system 100, the rendering and dynamic interaction program 170 may also edit or modify the initial UIDL dataset representing the initial UI state. For instance, the program 170 can edit the initial UIDL dataset with a text or visual editor to revise the initial UI state so that its more closely corresponds to information that the user has input to the system 100.

After obtaining the initial UIDL dataset representing an initial UI state for the system 100, the rendering and dynamic interaction program 170 may cause the processor 130 to interactively render UIs. For example, the program 170 may include a runtime rendering engine, which causes the processor 130 to produce a converted GUI by converting UIDL definitions in the UIDL dataset stored in the memory 140 into interactive graphical elements using web technologies (e.g., HTML, JS, CSS, Web Components), native mobile frameworks, desktop UI frameworks, immersive VR/AR scene renderers, etc. The converted GUI is fully interactive and supports real-time responsiveness to user actions.

In accordance with some embodiments, the rendering and dynamic interaction program 170 includes an event handling engine. When the user of the system 100 (e.g., a human user, application, or other computer entity) interacts with UI elements (such as via mouse clicks, drags, touch, text, and voice inputs), these interactions are captured by the event handling engine as events and stored in the memory 140 as data representing the captured events. The program 170 then causes the processor 130 to encapsulate the data representing the captured events. Then, the program 170 prepares to operate with the LLM 114 based on the encapsulated data. As the rendering and dynamic interaction program 170 operates with the LLM 114 to process data corresponding to incoming events, the system 100 achieves real-time UI adaptation. In some examples, the program 170 also operates with the LLM 114 to invoke functions to gather additional external data or update the underlying system 100's UI states. Examples of such external data include permissions and roles of certain users, pricing and quotas of certain goods and/or services, inventory and service availability, calendar of events, etc. Based on evolving context of the interactions and ongoing interactions with the user, the rendering and dynamic interaction program 170 operates with the LLM 114 to continuously modify and regenerate portions of the UIDL data collection maintained and stored in the memory 140. As a result of the continuously and/or iteratively updated UIDL data collection, the processor 130 operates with the LLM 114 to adapt the generated GUI seamlessly in real-time.

In another embodiment, the rendering and dynamic interaction program 170 receives multimodal inputs and timers for the real-time and dynamic generation of UIs. For example, the processor 130 inputs, processes and/or outputs data or messages representing multimodal interactions (such as voice conversation, video, etc.) and handles event triggers based on timers or external conditions to improve dynamic UI responsiveness to various input types and temporal constraints associated with the system 100. For example, events external to the UI (such as timers, audio/video inputs, and incoming API calls) are provided to the LLM 114 and processed in similar ways as the UI events. Based on an external event, the LLM 114 may update the UIDL data or end the current UI interaction with the user. For instance, when the generated UI displays a quiz question for the user to answer, the LLM 114 may decide to limit the time for the user to answer to 60 seconds. Accordingly, the LLM 114 calls a timer function to request an alert after the time limit of 60 seconds expires. After 60 seconds have passed, the timer function calls back to the LLM 114. If the user still has not answered at this point, the LLM 114 determines that time has expired and updates the UIDL data such that the “Submit Answer” button and interaction in the UI would be disabled.

During any continuous rendering and interaction loop performed by the rendering and dynamic interaction program 170 for real-time and dynamic generation of UIs, some or all of the state data representing UI states and value states is persisted, maintained, and stored independently outside of the operating session of the LLM 114. Such independent state persistence and management operation of the system 100 enables continuity and seamless session resumption between multiple cycles of operation with the LLM 114 and ensures robustness against interruptions or errors. For example, the system state management program 160, which is executed by the processor 130 rather than the LLM 114, holds the authoritative UI data (such as field values, validation status, component version, etc.) in data storage controlled by the program 160. As a result, a user can retrieve a UI state that has been rendered before without re-querying the LLM 114 and getting a potentially inconsistent result. Also, multiple agentic AIs can act on the same UI state if needed. The processor 130 can operate with the system state management program 160 and the LLM 114 to query states associated with the UI generation at any time through functions.

The user interaction that helps generate the real-time and dynamic UIs via the continuous rendering and interaction loop performed by the program 170 may conclude based on certain types of user inputs (e.g., when the processor 130 receives data that the user closed the interface window or a “stop,” “done,” or “quit” message from the user). Alternatively, the interaction generating real-time and dynamic UIs concludes when the processor 130 receives data or message indicating that the LLM 114 determines that the goal of the interaction has been achieved. For example, when the user initially requests to book a non-stop flight from New York's JFK airport to Tokyo's Narita airport, and the LLM 114 and/or system 100 outputs a confirmed booking conforming to conditions and preferences acquired from the user after the user navigates through and completes several pages of dynamically rendered UIs, the system 100 may determine that the task or goal has been completed. When the interaction generating real-time and dynamic UIs concludes, the final structured output is compiled by the processor 130 and returned to the initiating system or AI agent that invoked the system 100.

As explained above, embodiments of a real-time and dynamic UI generation system, such as the system 100, enables an Al-driven UI generation process that dynamically adapts to context, user preferences, and ongoing feedback, resulting in highly flexible, intuitive, and adaptive graphical interfaces for diverse applications. Moreover, such a system provides for a more natural, “human-like” UI.

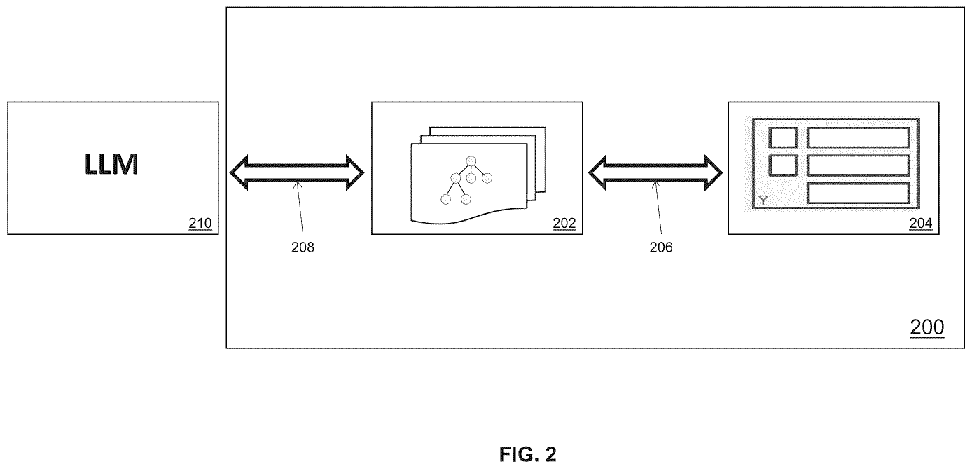

FIG. 2 is a simplified functional diagram illustrating the operation of the real-time and dynamic generation of UIs, in accordance with some embodiments. In the illustrated example, a User Interface Definition Language (UIDL) data structure 202 represents a graphical user interface (GUI). For example, the UIDL data structure 202 can take the form of a tree data structure, which encodes various component nodes (e.g., buttons, forms, images, controls, containers, and layout primitives, etc.), their respective node properties, and interaction events captured and/or listened to by the computing system (e.g., mouse click, finger swipe, drag-and-drop, text inputs, voice inputs, etc.). Further, the node may be coupled together via links that define a hierarchical relationship among the nodes. The UIDL data structure 202 is communicatively coupled to a rendering of the GUI 204 by a set of synchronizing functions 206. The rendering of the GUI 204 can be displayed within target platforms and/or devices (e.g., web browser, mobile device, desktop computer, AR/VR environments and devices, etc.). The synchronizing functions 206, for example, include web technologies (e.g., HTML, JS, CSS, Web Components), native mobile frameworks, desktop UI frameworks, or immersive VR/AR scene renderers, etc.

The UIDL data structure 202, the rendering of a GUI 204, and the synchronizing functions 206 operate in a computing environment 200 which may include a processor, a memory device, and a non-transitory data storage. For example, such a computing environment may correspond to the computing device 110 or system 100 described above in FIG. 1. The rendering of the GUI 204 may be displayed on a physical display device coupled to the computing environment 200 over the computing environment 200's display link (e.g., HDMI, MIPI DSI, DisplayPort, etc.). Additionally or alternatively, the rendering 204 may include audio or voice components that are output via a speaker coupled to the computing environment 200.

In an embodiment, the synchronizing functions 206 establish a dataflow channel that conveys snapshots of the UIDL data structure 202 from the memory device that stores the structure 202 to a presentation pipeline for displaying the underlying rendering of GUI 204. Further, when changes to an application state of the GUI or user input events on the GUI are recorded in the memory device, an LLM model 210 responds accordingly, and the resultant changes are applied to the UIDL data structure 202 by the processor as an ordered stream. Then, the synchronizing functions 206 ensure the mapping correspondence between the UIDL data structure 202 and the rendering of the GUI 204. During the ordered stream, the synchronizing functions 206, for example, capture low-level input (such as pointer, keyboard stroke, mouse click, touch, text input, voice input, and/or assistive-technology actions), associate the input with a corresponding component node of the UIDL data structure 202, and update GUI states to trigger another GUI rendering cycle as needed. This, in turn, may modify the UIDL data structure, which in turn, may modify at least one or more aspects of the rendering of the GUI 204 displayed or call an external function to output sound via the speaker. Furthermore, prior versions of the UIDL data structure 202 can be stored in memory to support rollback, debugging, editing, and/or review. These prior versions can also be rendered again in another rendering cycle, depending on the application state, user input events, context, etc.

In another embodiment, the rendering of the GUI 204 can be cached and stored in a dedicated database in the memory and/or in a data storage of the computing environment 200. During the current continuous rendering and interaction loop for real-time and dynamic generation of UIs, or any of future continuous rendering and interaction loops, when a new UI request or prompt for generating UI comes in, which is comparable to the request or prompt represented by the cached data, the initial rendering of GUI can be fetched from the cached rendering.

In the example illustrated by FIG. 2, the UIDL data structure 202 is also communicatively coupled to an AI model such as the LLM 210 by a set of dynamic interaction functions 208. The LLM 210 and the dynamic interaction functions 208 can operate in the same computing environment 200 as the UIDL data structure 202 and/or in a separate computing environment that is communicatively coupled to the computing environment 200 of the UIDL data structure 202.

In one embodiment, for dynamically generating and rendering UIs under the control of an AI agent without application-specific UI programming, the LLM 210 is trained and/or fine-tuned and/or prompted to generate UI specifications. The generated UI specifications are then materialized by the dynamic interaction functions 208 to form or update the UIDL data structure 202. The cooperation between the UIDL data structure 202 and the LLM 210 allows the AI agent to solicit user inputs as needed to complete tasks with compatibility and flexibility with heterogeneous client platforms. For example, when dynamically generating UIs, the agentic AI may not deploy a fixed, hard-coded UI page that has been pre-programmed for certain platforms (such as a web browser or a mobile application). Instead, the agentic AI utilizes UIs rendered at runtime on whatever platform or device that the user is using in real-time. Because the generation of UIs targets an abstract component schema (which may be defined by the UIDL) rather than application-specific or platform-specific programming language code, the same UI interaction can be provided on a web browser, a mobile application, desktop application, or any other platform/device. The dynamic interaction functions 208 can generate a prompt to the LLM 210 based on the UIDL data structure 202. The prompt may be hierarchical. For example, a hierarchical prompt is organized in layered sections such that the LLM 210 sees constraints first, then allowed outputs, then facts about the current task, and then the specific interaction needed. Further, the prompt may be based on, for example, task intent derived from interaction context and application requirements. For example, the LLM 210 may be prompted to “find a non-stop flight from San Francisco (SFO) airport to Narita (NRT) airport and ask the user for departure/return dates.” Additionally or alternatively, the prompt may be a constrained UI schema defining UI component types. For example, the LLM may be prompted to conform to specific JSON fields (such as “ui_schema_id” and a “components[] array” of fields like “id”, “label”). The prompt may additionally or alternatively be based on a UI interaction event (for instance, a mouse click, a finger swipe, a drag-and-drop operation, etc.) received from the user via the synchronizing functions 206 as described above.

On the other hand, the LLM 210 may return and/or update a structured UI specification encoded in a pre-defined format, such as a format defined by UIDL. The structured UI specification includes, for instance, component nodes (for instance, buttons, forms, images, controls, containers, and layout primitives, etc.), their respective node properties, and bindings to UI state variables. As described above, updates and changes to the UIDL data structure 202 in turn triggers another GUI rendering cycle that is synchronized with the synchronizing functions 206.

In another embodiment, the dynamic interaction functions 208 may cause the LLM 210 to interact with external systems (e.g., other computers, Internet servers, cloud computing servers, other applications) through function calls to request more information as needed for the user interaction or to store data or requests as an output from the user interaction.

In various embodiments, the benefits of the closed-loop cooperation between the synchronizing functions 206 and the dynamic interaction functions 208 may include (without limitation) one or more of the following: (1) decoupling UI interaction from application-specific UI programming which allows rapid adaptation across agentic AI tasks without the need to program new UI forms; (2) improving user experience through component abstraction that encapsulates a flexible and well-designed UI; (3) reducing user burden through progressive and iterative UI interaction; and (4) providing portability of the UI specification to multiple heterogeneous client platforms (As described above, the agentic AI utilizes UIs rendered at runtime on whatever platform or device that the user is using at real-time). During operation, an AI agent can continuously leverage this closed-loop cooperation between the synchronizing functions 206 and the dynamic interaction functions 208 to request inputs used to execute tools and their tasks, including generating and rendering UIs, while eliminating the need for hard-coded static UIs.

FIG. 3 illustrates in an example how a UI may be updated in a system for real-time and dynamic generation of UIs, in accordance with some embodiments. The functions used in this example may be performed in a computing environment such as the computing environment described above in FIG. 1. As shown in FIG. 3, the initial UI 302 includes various UI elements, layouts, and interactions for an “Invoice Approval” interface. As shown, the interface includes buttons 304: an “Approve” text button prompting a user to approve the invoice and a “Reject” text button prompting the user to reject the invoice. The interface further includes a “Delegate” text button, which the user can select/click if the user would like to delegate the approval of the invoice to someone else. Before any user interacts with initial UI 302, the data representing the UI 302 is stored in the computing environment and maintained by synchronizing computer functions such as the synchronizing functions 206 described in conjunction with FIG. 2. The synchronizing functions executed by the processor of the computing environment ensure in each state that a UI corresponds to its underlying data.

A UIDL data excerpt 306 of a UI data structure for the initial UI 302 is also shown in FIG. 3. As noted by underlining in the data excerpt 306, the data for the “Delegate” text button may include the text “<vaadin-button id=“delegate-button” tabindex=“0” role=“button”>Delegate</vaadin-button>” that defines the “Delegate” text button. When a user clicks the “Delegate” text button, a UI event is created and recorded in the computing environment by the processor. For instance, the recorded UI event can be characterized as “User: delegate on component delegate-button with changes: { }” which is associated with the “Delegate” text button.

The recorded UI event is then passed to an LLM, such as the LLM 210 in FIG. 2, by computer dynamic interaction functions, such as the functions 208 described above in conjunction with FIG. 2. The LLM, in turn, responds to the recorded UI event, for instance, with a UIDL command that is used to change the UIDL data structure (such as the data structure 202 in FIG. 2) representing the initial UI. For example, the command may change the displayed buttons 304 and may include the text “Replace node: target=button-layout, new=VerticalLayout (id=delegate-layout, props=1, children=2),” which is recognized by and compatible with the data structure representing UIs. Namely, the text of the UIDL command above instructs the data structure to replace the three-button layout in the initial UI 302 to a different, vertical layout. In other words, the response from the LLM identifies the part of the UIDL data structure that will be updated in response to the recorded UI event.

FIG. 3 shows an updated UI 310 and a corresponding data excerpt 308 of an updated UI data structure for the UI 310 based on the UIDL command output from the LLM in response to the recorded UI event. The updated data structure is characterized by properties associated with a class “delegate-layout.” When executed by the processor of the computing environment, the synchronizing functions render the updated UI 310 based on the updated data structure. The updated UI 310 includes layout elements and interactions, such as (1) a “Choose an approver” pull-down menu to allow a user to choose someone to approve the invoice, (2) a “Confirm” text button to allow the user to confirm her selection, and (3) a “Cancel” button to allow the user to cancel her selection and choose another approver. When a user takes further action on the updated UI 310, a new real-time and dynamic cycle of UI generation is triggered in the computing environment. The operation of real-time and dynamic UI generation described in the illustrated example can occur without predefined business logic, static UI components, or manual application programming development.

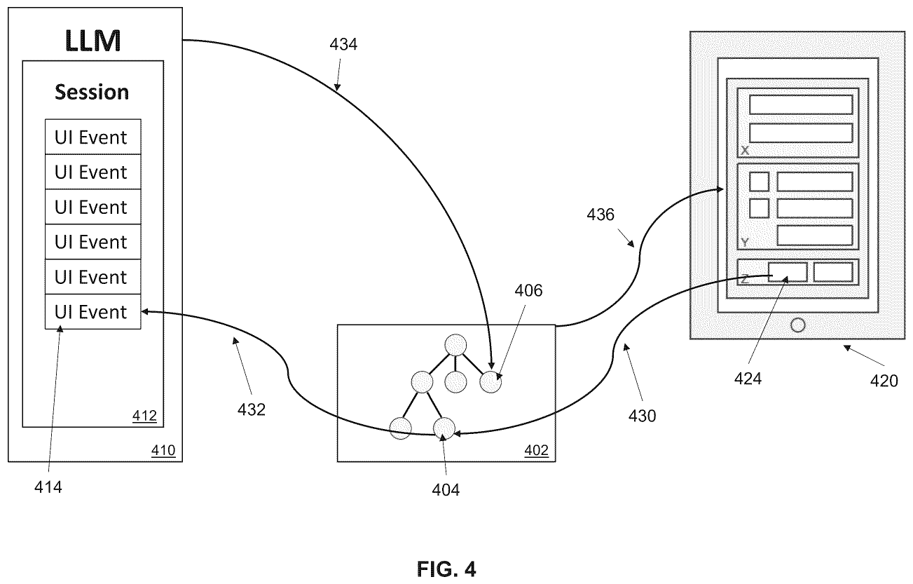

FIG. 4 is a simplified functional diagram illustrating the operation of the real-time and dynamic generation of UIs, in accordance with some embodiments. In the illustrated example, at a given UI state, a User Interface Definition Language (UIDL) data structure 402 represents a graphical user interface (GUI) 420 in a computing environment, such as the computing environment described above in FIG. 1. For instance, the UIDL data structure 402 may be a tree data structure as described above in FIG. 2. Also as described above in FIG. 2, UI synchronizing functions (e.g. functions 206) executed by a processor in the computing environment can ensure the mapping correspondence between the UIDL data structure 402 and the GUI 420 as described above. Applicable platforms and/or devices for outputting (e.g., GUIs) include web browsers, mobile devices, desktop computers, AR/VR environments and devices, etc. Technologies utilized for rendering and synchronizing GUIs, for instance, include web technologies (e.g., HTML, JS, CSS, Web Components), native mobile frameworks, desktop UI frameworks, immersive VR/AR scene renderers, etc.

In some embodiments, the UIDL data structure 402 includes a component node 404 corresponding to a UI element 424 of the GUI 420. Properties of the component node 404 include interaction events (e.g., click, swipe, drag-and-drop, etc.) that a user can perform on the UI element 424 of the GUI 420. At step 430 in the illustrated example, when the user performs an interaction event on the UI element 424, a UI event is recorded in the computing environment. Specifically, the UI synchronizing functions capture this UI event and operate on the component node 404 of the UIDL data structure 402 with its associated UI state.

As described above in FIG. 2, the UIDL data structure 402 is communicatively coupled to an LLM 410 in the computing environment. Dynamic interaction functions, such as the functions 208 described above in FIG. 2, can generate a prompt to the LLM 410 based on the UIDL data structure 402 and its associated UI state. The prompt is based on, for example, task intent derived from the interaction context and application requirements, a constrained UI schema defining UI component types, and/or UI interaction event (for instance, click, swipe, drag-and-drop, etc.) received from the user. Examples of interaction contexts, application requirements, and constrained UI schemas defining UI component types were previously explained above. The UI event captured at step 430 is passed to the LLM 410 at step 432.

As further shown in FIG. 4, the LLM 410 includes an LLM session 412, which further comprises a plurality of UI events. The UI event that is captured at step 430 and then passed to the LLM 410 is received by the LLM 410 as a UI event 414 at step 432. Based on the received UI event 414, at step 434, the LLM 410 determines how to update the UIDL data structure 402.

In some embodiments, the UIDL data structure 402 also includes a component node 406 corresponding to a UI layout that updates the GUI 420 from its initial UI state to an updated UI state. When the LLM 410 operates on the component node 406 of the UIDL data structure 402, as shown in step 434, it also updates the associated UI state. For instance, the operation carried out by the LLM 414 through dynamic interaction functions can change the number of rows of a grid layout in the GUI 420 with a UIDL command that is compatible with the UIDL data definitions.

Then, at step 436, the UI synchronizing functions, when executed by the processor of the computing environment, render an updated version of the GUI 420 according to the determination of LLM and UI definitions associated with the component node 406.

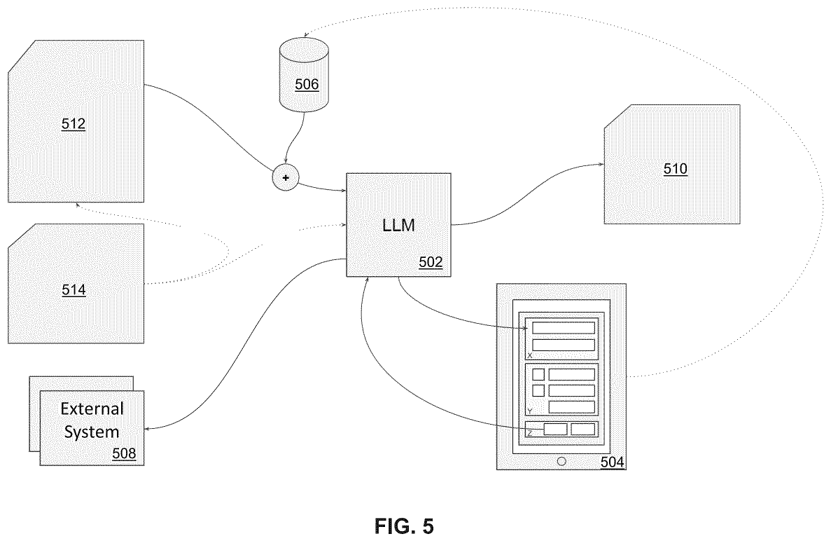

FIG. 5 is a simplified functional diagram illustrating the operation of the real-time and dynamic generation of UIs in a computing environment, such as the computing environment described above in FIG. 1, in accordance with some embodiments. In the illustrated example, during operations of real-time and dynamic UI generation, computer functions such as the rendering and dynamic interaction program described above in FIG. 1 allow for granular and dynamic updates of a UI 504 using an LLM 502. For example, the rendering and dynamic interaction program causes the processor to continuously render and interact in operation loops for real-time and dynamic generation of UIs without requiring predefined business logic, static UI components, or manual application development. At the beginning of an operation loop, the rendering and dynamic interaction program interacts with the LLM 502 to generate an initial version of the UI 504. The UI 504 can be rendered into a fully interactive GUI on target platforms and/or devices (for instance, web browser, mobile device, desktop computer, or AR/VR environments and devices).

In accordance with some embodiments, the initial version of the UI 504 can be cached and stored in a dedicated database 506. When a new UI request or prompt for generating UI comes in, the processor can fetch the initial version of the UI 504 from the database 506. When initializing an operation loop with the pre-stored initial UI representing an initial UI state, the computing environment saves processing time and reduces the latency of the UI generation. The initial UI can also guarantee that the initial UI state is identical or similar to what has been used previously by a user, improving consistency of the performance and allowing the human user to review the quality and approve the generated UI before the UI is sent to any other user, such as another human user, an application. And/or a computer entity. In some examples, based on user input, the initial UI can also be edited.

In an embodiment, a runtime rendering engine converts UIDL definitions into interactive graphical elements using standard web technologies (e.g., HTML/JS/CSS/Web Components), native mobile frameworks, desktop UI frameworks, or immersive VR/AR scene renderers. The GUI is fully interactive, supporting real-time responsiveness to user actions. User interactions with UI elements (such as mouse clicks, drags, touch, text inputs, voice inputs) are captured as events. These events are encapsulated and passed back into the LLM context. The LLM 502 processes incoming events, optionally invoking functions to gather additional external data from external systems 508 or update underlying system states. Based on evolving context and ongoing interactions, the LLM 502 continuously modifies and regenerates portions of the UIDL, causing the GUI to adapt seamlessly in real-time.

The system can support multimodal interactions (e.g., voice conversation, video, etc.) and event triggers based on timers or external conditions. These capabilities provide dynamic UI responsiveness to various input types and temporal constraints.

All state data (UI states and value states) persists outside of the LLM session, enabling continuity and seamless session resumption. This decoupling ensures robustness against interruptions or errors. The LLM 502 can query the state at any time through functions.

Interaction concludes either when explicitly terminated by the user (e.g., closing the interface window) or when the LLM determines that the goal of the user interaction is achieved. At this point, the final structured output is compiled and returned to the initiating system or agent. The outcome structure includes a structured definition of what information or final state the system returns upon completion, enabling clarity and precision when concluding interactions. A result database 510 can save results in structured output format (e.g., JSON) that is consistent with pre-defined result format.

External interactions with external systems 508 act as connectors or interfaces for retrieving additional data from external systems, such as databases, Application Programming Interfaces (APIs), calendars, or Internet of Things (IoT) sensors. They also enable actions such as creating calendar entries, initiating transactions, or updating records in external databases. Each function is documented, with clearly defined input and output structures that the LLM 502 can dynamically invoke as necessary during interactions.

In an embodiment, user-defined task descriptions, result format, budget of system operations, and background data are provided in a prompt 512.

In another embodiment, UIDL definitions included in User Interface Definition Language (UIDL) data collections, data representing UI best practices, and algorithms representing rule-based operations of the generation of UIs are saved in a fine-tuning database 514.

Data provided in the prompt 512 and the fine-tuning database 514 can be used to prompt and/or fine-tune the LLM 502 for generating UIs without requiring predefined business logic, static UI components, or manual application development. For example, the LLM 502 can be fine-tuned or prompted to operate with a User Interface Definition Language (UIDL). UIDL comprises a comprehensive syntax to define UI elements, interactions, component structures, and behaviors independent from underlying application logic. In some examples, the prompt 512 and the fine-tuning database 514 are combined to prompt the LLM 502 for UI generation. In other examples, the LLM 502 is fine-tuned using the fine-tuning database 514 and then prompted with the prompt 512.

Fine-tuning includes training the LLM 502 on patterns of optimal UI design, usability principles, and responsive interaction techniques. The training dataset encompasses recommended layouts, standard interaction flows, best practices, and typical UI metaphors. However, the LLM 502 is not limited to predefined examples, utilizing its generalized intelligence to dynamically invent new, contextually appropriate UI solutions. Throughout system usage, human users can provide explicit feedback on the usability, effectiveness, and clarity of generated UIs. This continuous feedback loop allows incremental retraining or online fine-tuning of the model, progressively refining its UI-generation capabilities.

The operation with the LLM 502 adheres to predefined rules establishing interaction boundaries, appropriate behaviors, cultural sensitivity, tone of voice, and permissible content. Regular evaluations and iterative updates ensure outputs remain aligned with organizational, ethical, and regulatory standards.

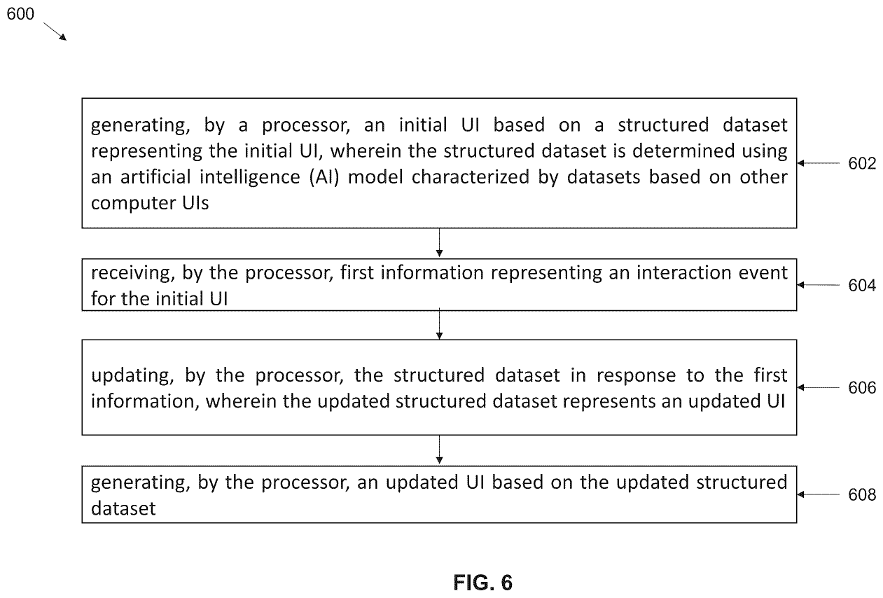

FIG. 6 is a flow chart illustrating an exemplary method 600 for generating agentic AI user interfaces (UIs), in accordance with some embodiments. The steps of the method 600 are performed by computer processors in a computing environment such as that described above in FIG. 1. In the illustrated example, the method 600 includes, at step 602, generating an initial UI based on a structured dataset representing the initial UI. The structured dataset (such as UIDL data) is determined using an artificial intelligence (AI) model such as an LLM model that has been characterized by datasets based on other computer UIs. For example, as described above, the LLM model may be fine-tuned using UIDL data and then prompted with task descriptions, result formats, budget of system operations, and/or background data. The LLM model may also be prompted with a combination of fine-tuning data and other prompt information. In another embodiment, the initial UI can be cached and stored for future new UI requests or prompts for generating UI.

At step 604, the method 600 includes receiving first information representing an interaction event for the initial UI. In some embodiments, additional information representing a multi-modal input other than the interaction event is also received. For example, as described above, interaction events are captured and/or listened to by the computing system (e.g., mouse click, finger swipe, drag-and-drop, text inputs, voice inputs, etc.).

At step 606, the method 600 includes updating the structured dataset (such as UIDL data) in response to the first information and the updated structured dataset represents an updated UI that can be rendered. In some embodiments, additional information representing a multi-modal input is also used to update the structured dataset. For example, as described above, when changes to an application state of the UI or user input events on the UI are recorded, an LLM model responds accordingly, and the resultant changes are applied to the UIDL data. Then, the synchronizing functions ensure the mapping correspondence between the UIDL data and the UI to be rendered.

In turn, at step 608, the method 600 includes generating an updated UI based on the updated structured dataset (such as UIDL data). For example, as described above, a runtime rendering engine converts UIDL definitions into interactive graphical elements using standard web technologies (e.g., HTML/JS/CSS/Web Components), native mobile frameworks, desktop UI frameworks, or immersive VR/AR scene renderers. The GUI is fully interactive, supporting real-time responsiveness to user actions.

In a further embodiment, the method 600 further includes repeating steps 604 through 608. For example, as described above, based on evolving context of the interactions and ongoing interactions with the user, rendering and dynamic interaction programs operate with the LLM to continuously modify and regenerate portions of the UIDL data. As a result of the continuously and/or iteratively updated UIDL data, the processor operates with the LLM to adapt the generated GUI seamlessly in real-time.

### ADDITIONAL EXAMPLE EMBODIMENTS

In an embodiment, a method for user interface (UI) generation comprises: generating, by a processor, an initial UI based on a structured dataset representing the initial UI, wherein the structured dataset is determined using an artificial intelligence (AI) model characterized by datasets based on other computer UIs; receiving, by the processor, first information representing an interaction event for the initial UI; updating, by the processor, the structured dataset in response to the first information, wherein the updated structured dataset represents an updated UI; and generating, by the processor, an updated UI based on the updated structured dataset. In accordance with some embodiments, the AI model is a Large Language Model (LLM).

In another embodiment, the structured dataset includes a plurality of nodes and a plurality of links connecting at least a portion of the plurality of nodes. In a further embodiment, at least a portion of the plurality of nodes of the structured dataset each represents a layout primitive of a UI; and at least a portion of the plurality of links of the structured dataset each represents a hierarchical relationship among the plurality of nodes.

In another embodiment, the disclosed method further comprises fine-tuning, by the processor, the AI model based on input data associated with the other computer UIs prior to determining, by the processor, the structured dataset using the AI model. In accordance with some embodiments, the disclosed method further comprises determining, by the processor, the structured dataset and/or the updated structured dataset using the AI model.

In another embodiment, the AI model is further characterized by datasets based on at least one task defined by a user of the initial UI. In accordance with some embodiments, the disclosed method further comprises receiving, by the processor, second information representing a multi-modal input other than the interaction event for the initial UI.

In a further embodiment, the disclosed method further comprises repeatedly updating, by the processor, the structured dataset in response to a sequence of received information; and repeatedly generating, by the processor, a sequence of updated UIs based on the updated structured datasets, wherein the sequence of information is generated via the sequence of updated UIs. Additionally, the processor may repeatedly update the structured dataset using the AI model.

In yet a further embodiment, the disclosed method further comprises storing the structured dataset representing the initial UI in memory.

In an embodiment, A user interface (UI) generation system comprises a computing device, the computing device including at least one processor and a memory device in communication with the at least one processor, wherein at least one processor, when executing instructions stored in the memory device, is configured to: generate an initial UI based on a structured dataset representing the initial UI, wherein the structured dataset is determined using an artificial intelligence (AI) model characterized by datasets based on other computer UIs; receive first information representing an interaction event for the initial UI; update the structured dataset in response to the first information, wherein the updated structured dataset represents an updated UI; and generate an updated UI based on the updated structured dataset. In accordance with some embodiments, the AI model is a Large Language Model (LLM).

In another embodiment, the structured dataset includes a plurality of nodes and a plurality of links connecting at least a portion of the plurality of nodes. In a further embodiment, at least a portion of the plurality of nodes of the structured dataset each represents a layout primitive of a UI; and at least a portion of the plurality of links of the structured dataset each represents a hierarchical relationship among the plurality of nodes.

In another embodiment, the at least one processor is further configured to fine-tune the AI model based on input data associated with the other computer UIs prior to determining the structured dataset using the AI model. In accordance with some embodiments, the processor is further configured to determine the structured dataset and/or the updated structured dataset using the AI model.

In another embodiment, the AI model is further characterized by datasets based on at least one task defined by a user of the initial UI. In accordance with some embodiments, the processor is further configured to receive second information representing a multi-modal input other than the interaction event for the initial UI.

In a further embodiment, the processor is further configured to repeatedly update the structured dataset in response to a sequence of received information; and repeatedly generate a sequence of updated UIs based on the updated structured datasets, wherein the sequence of information is generated via the sequence of updated UIs. Additionally, the processor may repeatedly update the structured dataset using the AI model.

In yet a further embodiment, the processor is further configured to store the structured dataset representing the initial UI in the memory device.

In another embodiment, a system for dynamically generating user interfaces, comprises: a Large Language Model (LLM) engine configured to generate a User Interface Definition Language (UIDL) representation based on user input, context, and AI-driven processing; a runtime UI rendering engine configured to interpret the UIDL representation and generate a corresponding graphical user interface (GUI) in real-time; and an event feedback engine configured to capture user interactions with the GUI and update the LLM for continuous UI adaptation and refinement.

In another embodiment, the UIDL representation comprises structural definitions for UI elements, including buttons, input fields, tables, forms, diagrams, vector graphics, and raster images; layout properties defining positioning, visibility, and hierarchical relationships between elements; and declaration of actions a user can take on the UI elements, such as clicks, text inputs, and selections.

In another embodiment, the LLM engine is configured to generate UIDL based on goals to seek approval from human for a task driven by an LLM model; ask for a guidance from a user to help on the task; and teach or explain ideas, summarized information, and raw data to the user.

In another embodiment, the runtime UI rendering engine is configured to interpret UIDL-based UI structures and generate a fully interactive GUI; render UI components in a web, mobile, desktop, virtual reality, augmented reality, or embedded system environment; and modify the GUI dynamically based on further UIDL-based instructions from the LLM engine.

In another embodiment, the event feedback engine is configured to capture user-generated events such as mouse clicks, text input, selections, drag-and-drop interactions, hand gestures, and touch gestures; send the captured events to the LLM engine for processing and UI adjustments; and facilitate a continuous feedback loop of real-time UI adaptation.

In another embodiment, the UIDL and UI updates are processed by the system in real-time to change the UI elements based on updated user inputs; perform multimodal interaction, including text, voice, and camera inputs; and to update state of the task output based on the updated user inputs.

In another embodiment, the UI generation system is interfaced to external systems such as decision support systems; business process management systems; teaching or educational systems; self-service systems; and organization management and work coordination systems.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include various forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The subject matter described herein can take the form of an entirely software embodiment or an embodiment containing both hardware and software elements.

The flow diagrams in the figures illustrate the architecture, functionality, and operation of possible implementations of the disclosed systems and methods. In some alternative implementations, the steps noted in the figures can occur out of the order noted in the figures. For example, two steps shown in succession can, in fact, be performed substantially concurrently, or the blocks can sometimes be performed in the reverse order, depending upon the functionality involved.

What is claimed is:

1. A method for user interface (UI) generation, comprising:
generating, by a processor, an initial UI based on a structured dataset representing the initial UI,
wherein the structured dataset is determined using an artificial intelligence (AI) model characterized by datasets based on other computer UIs;
receiving, by the processor, first information representing an interaction event for the initial UI;
updating, by the processor, the structured dataset in response to the first information,
wherein the updated structured dataset represents an updated UI; and
generating, by the processor, an updated UI based on the updated structured dataset.

2. The method of claim 1, wherein the structured dataset includes a plurality of nodes and a plurality of links connecting at least a portion of the plurality of nodes.

3. The method of claim 2, wherein:
at least a portion of the plurality of nodes of the structured dataset each represents a layout primitive of a UI; and
at least a portion of the plurality of links of the structured dataset each represents a hierarchical relationship among the plurality of nodes.

4. The method of claim 2, further comprising:
fine-tuning, by the processor, the AI model based on input data associated with the other computer UIs prior to determining, by the processor, the structured dataset using the AI model.

5. The method of claim 1, further comprising:
determining, by the processor, the structured dataset using the AI model.

6. The method of claim 5, further comprising:
determining, by the processor, the updated structured dataset using the AI model.

7. The method of claim 1, further comprising:
determining, by the processor, the updated structured dataset using the AI model.

8. The method of claim 7, further comprising:
fine-tuning, by the processor, the AI model based on input data associated with the other computer UIs prior to determining, by the processor, the structured dataset using the AI model.

9. The method of claim 1, wherein the AI model is a Large Language Model (LLM).

10. The method of claim 1, wherein the AI model is further characterized by datasets based on at least one task defined by a user of the initial UI.

11. The method of claim 1, further comprising:
receiving, by the processor, second information representing a multi-modal input other than the interaction event for the initial UI.

12. The method of claim 1, further comprising:
repeatedly updating, by the processor, the structured dataset in response to a sequence of received information; and
repeatedly generating, by the processor, a sequence of updated UIs based on the updated structured datasets,
wherein the sequence of information is generated via the sequence of updated UIs.

13. The method of claim 12, wherein the processor repeatedly updates the structured dataset using the AI model.

14. The method of claim 1, further comprising:
storing the structured dataset representing the initial UI in memory.

15. A user interface (UI) generation system comprising:
a computing device, the computing device including at least one processor and a memory device in communication with the at least one processor, wherein at least one processor, when executing instructions stored in the memory device, is configured to:
generate an initial UI based on a structured dataset representing the initial UI,
wherein the structured dataset is determined using an artificial intelligence (AI) model characterized by datasets based on other computer UIs;
receive first information representing an interaction event for the initial UI;
update the structured dataset in response to the first information,
wherein the updated structured dataset represents an updated UI; and
generate an updated UI based on the updated structured dataset.

16. The system of claim 15, wherein the structured dataset includes a plurality of nodes and a plurality of links connecting at least a portion of the plurality of nodes.

17. The system of claim 16, wherein:
at least a portion of the plurality of nodes of the structured dataset each represents a layout primitive of a UI; and
at least a portion of the plurality of links of the structured dataset each represents a hierarchical relationship among the plurality of nodes.

18. The system of claim 16, the processor further configured to:
fine-tune the AI model based on input data associated with the other computer UIs prior to determining the structured dataset using the AI model.

19. The system of claim 15, the processor further configured to determine the structured dataset using the AI model.

20. The system of claim 19, the processor further configured to determine the updated structured dataset using the AI model.

21. The system of claim 15, the processor further configured to determine the updated structured dataset using the AI model.

22. The system of claim 21, the processor further configured to:
fine-tune the AI model based on input data associated with the other computer UIs prior to determining the structured dataset using the AI model.

23. The system of claim 15, wherein the AI model is a Large Language Model (LLM).

24. The system of claim 15, wherein the AI model is further characterized by datasets based on at least one task defined by a user of the initial UI.

25. The system of claim 15, the processor further configured to receive second information representing a multi-modal input other than the interaction event for the initial UI.

26. The system of claim 15, the processor further configured to:
repeatedly update the structured dataset in response to a sequence of received information; and
repeatedly generate a sequence of updated UIs based on the updated structured datasets,
wherein the sequence of information is generated via the sequence of updated UIs.

27. The system of claim 26, wherein the processor is further configured to repeatedly update the structured dataset using the AI model.

28. The system of claim 15, the processor further configured to:
store the structured dataset representing the initial UI in the memory device.
